(19) United States
(12) Patent Application Publication
(10) Pub. No.: US 2014/0331205 A1
(43) Pub. Date: Nov. 6, 2014

(54) Program Testing Service

(71) Applicant: Amazon Technologies, Inc., (US)

(72) Inventor: Lokendra Singh, New Delhi (IN)

(21) Appl. No.: 13/875,955

(22) Filed: May 2, 2013

(51) Int. Cl. G06F 11/36

(52) U.S. Cl. CPC G06F 11/3664
USPC 717/124; 709/227

(57) ABSTRACT

A service provider network includes host computers that have various computing devices connected thereto. In order to test the operation of a program, a developer creates a program and one or more test cases for use in testing the program. The developer also identifies devices in the service provider network for use in testing the program. Once this selection has been made, a test request is submitted to the service provider network. When the service provider network receives the test request, the program is installed on the devices upon which testing is to be performed. The supplied test case is then utilized to test various aspects of the operation of the program on the devices. Once the testing of the program has completed, the results of the testing may be transmitted to the developer. A similar process might be utilized to test a program on a variety of device emulators.

### BACKGROUND

The number of available models of smartphones and tablet computing devices has grown exponentially during the last few years. For example, in the last several years, the number of available smartphone models that are configured to execute the ANDROID operating system has grown significantly. Similar growth has also occurred in the number of available models of tablet devices that are configured to execute the ANDROID operating system. Other types of computing devices executing the ANDROID operating system have also shown significant growth. The number of available models of smartphones, tablets, and other computing devices executing other operating systems have also seen tremendous growth recently.

The various models of smartphones, tablets, and other computing devices described above frequently have different hardware configurations, even when the devices are configured to execute the same operating system. For example, different smartphone models based upon the ANDROID operating system might include different processors, different amounts of memory, and different peripheral devices, such as cameras, global positioning system (“GPS”) sensors, and others. These devices might also include significant variations in software configurations. For example, some models might be configured with different versions of the ANDROID operating system and/or with different software installed on the devices by the manufacturers of the devices. Smartphone and tablet devices executing other operating systems from other manufacturers might also include great variations in hardware and software.

The significant variation in the software and hardware configuration of smartphone, tablet, and other types of computing devices can make it difficult for developers to create programs that execute properly on a wide range of devices. For example, a developer might test the operation of their program on a single device that they own. It is, however, usually cost prohibitive for a developer to purchase many physical devices to use for testing. While a developer might utilize a device emulator to test the execution of a program, device emulators might also have limitations on the type and depth of testing that can be performed. Additionally, device emulators might not be available for all available devices. As a result, a program created by a developer might not execute optimally on devices other than the physical device, or devices, that the developer is able to specifically test the execution of the program upon. A program that does not execute properly can be frustrating to both the developer and to the customers that purchase the program.

The disclosure made herein is presented with respect to these and other considerations.

### BRIEF DESCRIPTION OF THE DRAWINGS

FIG. 1 is a network architecture diagram showing an overview of one illustrative mechanism described herein for testing the operation of a program utilizing a program testing service, according to one embodiment disclosed herein;

FIG. 2 is a network architecture diagram showing aspects of one illustrative mechanism described herein for submitting a request to a program testing service to test the operation of a program, according to one embodiment disclosed herein;

FIG. 3 is a network architecture diagram showing aspects of one illustrative mechanism described herein for testing the operation of a program, and returning test results to a requestor following the testing, according to one embodiment disclosed herein;

FIG. 4 is a flow diagram showing aspects of the operation of a developer computer for requesting that a program service test a program, and for receiving and presenting the results of the testing of the program, according to one embodiment disclosed herein;

FIG. 5 is a flow diagram showing aspects of the operation of components in a service provider network for testing the operation of a program and for providing results of the testing, according to one embodiment disclosed herein;

FIG. 6 is a network architecture diagram showing aspects of one illustrative mechanism described herein for utilizing a direct connection between a developer computer and a device in a service provider network to test the operation of a program, according to one embodiment disclosed herein;

FIG. 7 is a flow diagram showing aspects of one illustrative routine disclosed herein for utilizing a direct connection between a developer computer and a device in a service provider network to test the operation of a program, according to one embodiment disclosed herein; and

FIG. 8 is a computer architecture diagram showing an illustrative computer hardware architecture for implementing a computing device that might be utilized to implement aspects of the various embodiments presented herein.

### DETAILED DESCRIPTION

The following detailed description is directed to technologies for providing and utilizing a program testing service. Utilizing the technologies described herein, a service provider can provide a network-based program testing service that includes functionality for permitting developers to test the operation of programs on a wide variety of physical computing devices and/or device emulators. Through the use of such a program testing service, a developer can quickly, easily and economically test the operation of a program on many physical computing devices, such as smartphones, tablets and, potentially, other types of device. Through this type of testing, the developer may improve the likelihood that their program will execute properly on a wide range of computing devices.

According to one aspect presented herein, a computer-implemented mechanism is disclosed for providing and utilizing a network-based program testing service. According to one embodiment, a service provider operates a service provider network that includes host computers that have various computing devices connected thereto. For example, host computers in the service provider network might have some number (e.g. six to sixteen) smartphones or tablet computing devices or other types of mobile computing devices connected thereto. As an example, a host computer in the service provider network might have sixteen smartphones connected thereto utilizing an appropriate connection type, such as a Universal Serial Bus (“USB”) connection. The connected devices might have different hardware and/or software configurations. Other types of devices might also be connected to the host computers for use in testing programs. As will be described in greater detail below, a developer can utilize the mechanisms disclosed herein to test the execution of a program on the devices connected to the host computers in the service provider network.

In some implementations, the service provider network might also include host computers having device emulators executing thereupon. For example, a host computer might be configured to execute some number (e.g. two or three) of device emulators in virtual machine instances. The device emulators might emulate the physical hardware of devices, like smartphones or tablet computers, having different hardware and/or software configurations. As will also be described in greater detail below, a developer can utilize the mechanisms disclosed herein to test the execution of a program on the device emulators executing on the host computers in the service provider network.

In order to test the operation of a program, the developer first creates the program in a convention fashion. For example, a developer might utilize a suitable program development environment to create the program. The developer then creates one or more test cases for use in testing the program. The test cases describe the manner in which the program should be tested. Additional details regarding the test cases will be presented below.

Once the developer has created the program and at least one test case for a program, the developer may be presented with a list of the available devices and/or device emulators for use in testing the operation of the program. The developer may then be permitted to select one or more devices and/or device emulators for use in testing the operation of the program. Once this selection has been made, a test request is submitted to a component in the service provider network. The test request may include the program, at least one test case, and data identifying the devices and/or device emulators that should be used for testing the operation of the program. The test request might be transmitted to the service provider network by way of the program development environment, through a page provided by the service provider network, such as a Web page in a Web portal, in an e-mail message, or in another manner.

When the service provider network receives a test request, a workflow coordinator or another component in the service provider network may determine whether the computing devices and/or device emulators that the program is to be tested on are available for use (i.e. not in use testing another program). If the devices and/or device emulators that the program is to be tested on are not available for use, the workflow component may cause the test request to be queued until such time as the devices and/or device emulators required for testing become available for use.

If the devices and/or device emulators are available for use, the workflow coordinator, in conjunction with other components in the service provider network, may cause the program to be installed on the devices and/or device emulators upon which testing is to be performed. The program is then executed on the devices and/or device emulators, and the supplied test case, or test cases, is utilized to test various aspects of the operation of the program. Testing might be performed on many devices and/or device emulators simultaneously. Real-time testing data might also be provided to the developer during the testing of the program. For instance, textual data or video screen data generated by a device or a device emulator upon which testing is being performed might be transmitted to the developer.

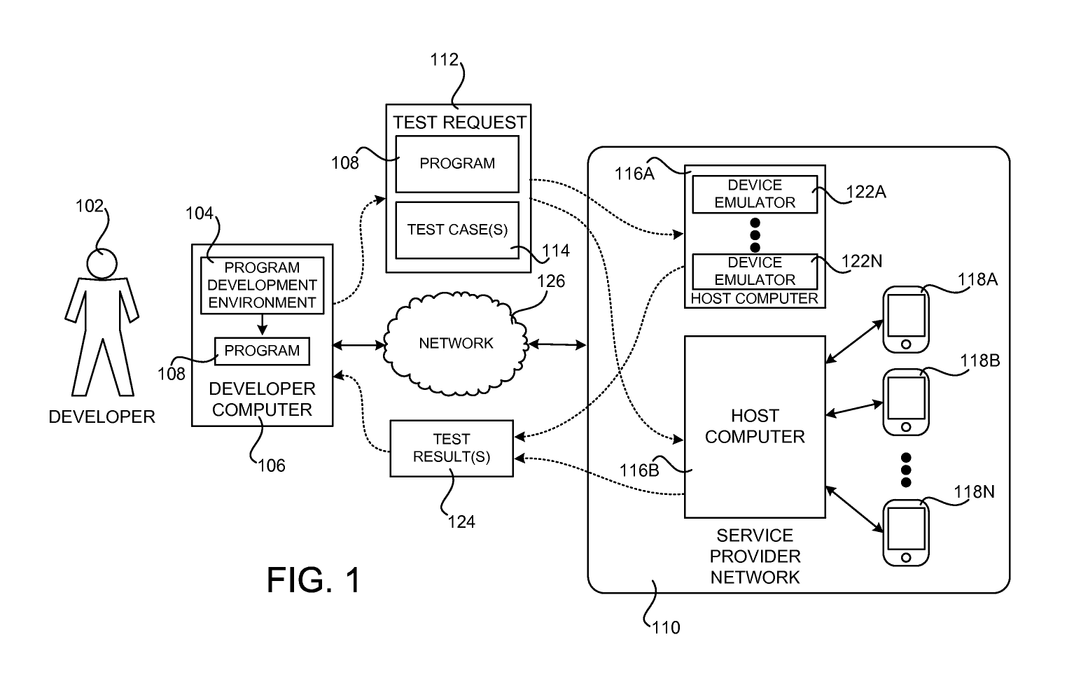

Once the testing of the program has completed, the results of the testing may be gathered and transmitted to the developer of the program. The results might include summary results (e.g. whether a particular test passed or failed), detailed results such as log files generated by the program or the test case, screen captures taken prior to, during, and/or after testing and, potentially, video captured from the device and/or device emulator during testing. The developer may then utilize the test results to modify aspects of the operation of the program. In this way, a developer can utilize the testing service described above to quickly, easily and economically test the operation of a program on many physical computing devices, such as smartphones or tablets, and/or device emulators for many different computing devices. Additional details regarding the various components and processes described above for providing and utilizing a network-based program testing service will be presented below with regard to FIGS. 1-6.

It should be appreciated that the subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, cellular telephone devices, special-purposed hardware devices, network appliances, and the like. As mentioned briefly above, the embodiments described herein may be practiced in distributed computing environments, where tasks may be performed by remote computing devices that are linked through a communications network. In a distributed computing environment, program modules may be located in both local and remote memory storage devices.

In the following detailed description, references are made to the accompanying drawings that form a part hereof, and that show, by way of illustration, specific embodiments or examples. The drawings herein are not drawn to scale. Like numerals represent like elements throughout the several figures (which may be referred to herein as a “FIG.” or “FIGS.”).

FIG. 1 is a network architecture diagram showing an overview of one illustrative mechanism described herein for testing the operation of a program 108 utilizing a network-based program testing service, according to one embodiment disclosed herein. As shown in FIG. 1, a developer 102 might utilize an appropriate developer computer 106 to execute a program development environment 104. As known in the art, a program development environment 104 is an environment that allows a user to create, compile, and execute a program, such as the program 108. For example, in one illustrative embodiment disclosed herein, the program development environment 104 is the ECLIPSE integrated development environment (“IDE”) from the ECLIPSE FOUNDATION. It should be appreciated, however, that other IDEs and other types of program development environments 104 from other vendors might also be utilized with the mechanisms disclosed herein.

In one implementation, the program 108 is an executable or interpreted program configured for executing on a computing device, such as a smartphone, a tablet computing device, an e-reader device, or another type of computing device. In this regard, it should be appreciated that while the embodiments disclosed herein are primarily presented in the context of smartphone computing devices, the embodiments disclosed herein might also be utilized with other types of computing devices. For example, and without limitation, the embodiments disclosed herein might be utilized with tablet computing devices, video game devices, set-top box devices, and other types of computing devices. The embodiments disclosed herein should not be construed as being limited to a smartphone device or a device from a particular manufacturer.

In order to test the operation of the program 108 with a variety of computing devices, the developer 102 might establish a connection to a service provider network 110 by way of the network 126. As will be described in greater detail below, the service provider network 110 is operated by a service provider, and is configured to provide a network-based service for testing a program, such as the program 108, on a variety of computing devices. The developer computer 106 might connect to the service provider network 110 through an appropriate network 126, such as the Internet. It should be appreciated that the network topology illustrated in FIG. 1 and the other FIGS. is merely illustrative, and that many more networks, networking devices, computing systems, and software components might be utilized to implement the various embodiments disclosed herein thank shown in the FIGS.

In order to test the program 108 on a variety of devices, the developer 102 might first define one or more test cases 114 for use in testing the operation of the program 108 on the specified devices. The test cases 114 describe the test, or tests, that should be performed on the program 108 while the program 108 is executing on various computing devices. For example, the test cases 114 might define simulated user input events that are presented to the device upon which the program 108 is being tested. In other implementations, the test cases 114 might define changes in orientation, configuration, and/or simulate the presence or removal of external devices. The test cases 114 might also define a stress test that sends pseudo random events to a device while a program 108 is being tested. The test cases 114 might also define other types of tests configured to test various aspects of the operation of a program 108, such as the impact on battery life, processor or memory usage, or other operational aspects. In certain embodiments, the service provider might also provide pre-defined test cases 114 for use by the developer 102. For instance, pre-defined test cases 114 might be provided for executing the program 108 and determining if any errors are encountered, for stress testing the program 108, and/or for performing other types of tests on the program 108.

When the devices upon which the program 108 is being tested are based upon the ANDROID operating system from GOOGLE, INC., the test cases 114 might be defined utilizing the ANDROID INSTRUMENTATION TESTING FRAMEWORK. Other formats might be utilized to define the test cases 114 when the devices utilized to test the program 108 are configured with operating systems from other manufacturers. In this regard, it should be appreciated that while the embodiments described herein are primarily presented in the context of testing a program 108 on computing devices utilizing the ANDROID operating system, the embodiments presented herein are not limited to use with such devices. For example, the embodiments disclosed herein might be utilized to test a program 108 on devices executing other types of operating systems from other manufacturers.

In some embodiments, various development tools might also be provided to assist a developer 102 in creating test cases 114 for use with the testing service provided by way of the service provider network 110. For example, in one implementation, a user interface (“UI”)-based software development tool may be provided that allows the developer 102 to record user interface interactions. These UI interactions may then be utilized to test functionality of the program 108 on the various computing devices provided by the service provider network 110. It should be appreciated that other types of software tools might also be provided for use by the developer 102 in utilizing and interacting with the various facilities provided by the service provider network 110 as described herein.

Once the developer 102 has completed the creation of the program 108 and the test cases 114, the developer 102 might be permitted to select one or more computing devices 118 within the service provider network 110 that are to be utilized for testing the operation of the program 108. For example, in various embodiments, a list of available devices 118 might be presented to the developer 102. In other implementations, the particular device 118, or devices 118, upon which a program is to be tested might be selected through any analysis of the program 108. For example, if the program 108 has been created for use with a particular operating system or device type, this information might be utilized to select the device 118, or devices, upon which the program 108 is to be tested.

In some embodiments, the developer 102 might also be permitted to test the operation of the program 108 on device emulators 122 provided by the service provider network 110. As known in the art, a device emulator 122 is a software emulation of a computing device. Utilizing this mechanism, a developer 102 can simultaneously test the operation of a program 108 upon actual physical computing devices 118 and upon device emulators 122.

According to various embodiments, the developer 102 can select the specific device, or devices that the developer 102 would like the program 108 to be tested upon. The developer 102 might also be permitted to select the devices by the operating system version that the devices are executing. In other implementations, the developer 102 might also be permitted to select devices for testing based upon the type of hardware, software, or other aspects of the devices. For example, the developer 102 might request that the program 108 be tested on devices having a camera and a particular version of the ANDROID operating system. In this regard, it should be appreciated that a developer 102 might be permitted to select devices, and/or device emulators, for use in testing the program 108 based upon one or more of, a device manufacturer, a device type, a device version, device hardware, operating system version, other software version, or other attributes of a device.

Once the developer 102 has generated the program 108, created the test cases 114, and selected the devices and/or emulators upon which the program 108 should be tested, a test request 112 might be transmitted to the service provider network 110. The test request 112 includes the program 108, the test cases 114, and data identifying the devices and/or emulators that the program 108 should be tested upon. In other embodiments, the various components of the test request 112 described above might be stored in other locations and references to these locations might be included in the test request 112. The various data described above in the test request 112 might be provided to the service provider network 110 in other ways in other implementations.

In response to receiving a test request 112, various components within the service provider network 110 are configured to cause the tests described by the test cases 114 to be performed on the program 108 while executing on the specified devices and/or device emulators. For instance, in the example shown in FIG. 1, the service provider network 110 includes a host computer 116B that has several computing devices 118A-118N attached thereto. In one implementation, the computing devices 118A-118N are various models of smartphones or tablet computing devices executing the ANDROID operating system. The computing devices 118A-118N might be connected to the host computer 116B by way of a suitable wired connection, such as a USB connection. The computing devices 118A-118N might also be connected to the host computer 116B by way of a suitable wireless connection.

In another implementation, the computing devices 118A-118N are smartphone devices that include only hardware that is unique to the device. For example, a device 118 might be a development motherboard that includes only a processor and memory that is unique to a particular model of mobile computing device. Other hardware devices utilized by the mobile computing device that are common across various devices might be emulated by software executing on the host computer 116. In this way, the cost of each of the devices 118A-118N might be reduced. Other types of development boards and or platforms might also be connected to a host computer 116 in the service provider network 110 for use in testing in the manner disclosed herein.

In the example shown in FIG. 1, the service provider network 110 also includes a host computer 116A that is executing a number of device emulators 122A-122N. The device emulators 122A-122N may be executing on the physical hardware of the host computer 116A, or in other embodiments might be executing within virtual machines executing on the host computer 116A. Other mechanisms for executing the device emulators 122A-122N might also be utilized.

In order to test the operation of the program 108, the program 108 is first installed on the computing devices 118A-118N and/or device emulators 122A-122N specified by the developer 102. Once the program 108 has been installed on the appropriate computing devices 118A-118N and/or device emulators 122A-122N, the test cases 114 can be utilized to test the operation of the program 108 upon the various computing devices 118 and/or device emulators 122. It should be appreciated that these tests might be performed simultaneously, thereby allowing a developer 102 to test the operation of a program 108 on multiple computing devices 118 and device emulators 122 simultaneously.

As will be described in greater detail below, the service provider network 110 might provide real-time testing data to the developer 102 while the test of the program 108 is being performed. For instance, text data might be provided to the developer computer 106 describing various aspects of the testing. In other implementations, a display output by the computing devices 118A-118N and/or the device emulators 122A-122N might be provided to the developer computer 106 while the testing of the program 108 is being performed. Other types of data might also be provided to the developer computer 106 during performance of the specified tests for use by the developer 102.

When the testing of the program 108 has completed, the service provider network 110 is configured to transmit test results 124 to the developer computer 106. As will be described in greater detail below, the test results 124 may include information for each computing device 118A-118N and device emulator 122A-122N that the tests were performed upon. The test results 124 might summarize the results of the testing and/or provide more detailed information regarding the performance of the testing. For example, the test results 124 can describe the success or failure of the tests, may provide logs and/or other information from the computing devices 118 and/or the device emulator 122 collected during the performance of the tests, and might provide other information in other embodiments. As will also be described in greater detail below, the test results 124 might also include screen displays captured from the computing devices 118A-118N and/or the device emulator 122A-122N during the performance of the tests. The test results 124 might also include other information in other embodiments.

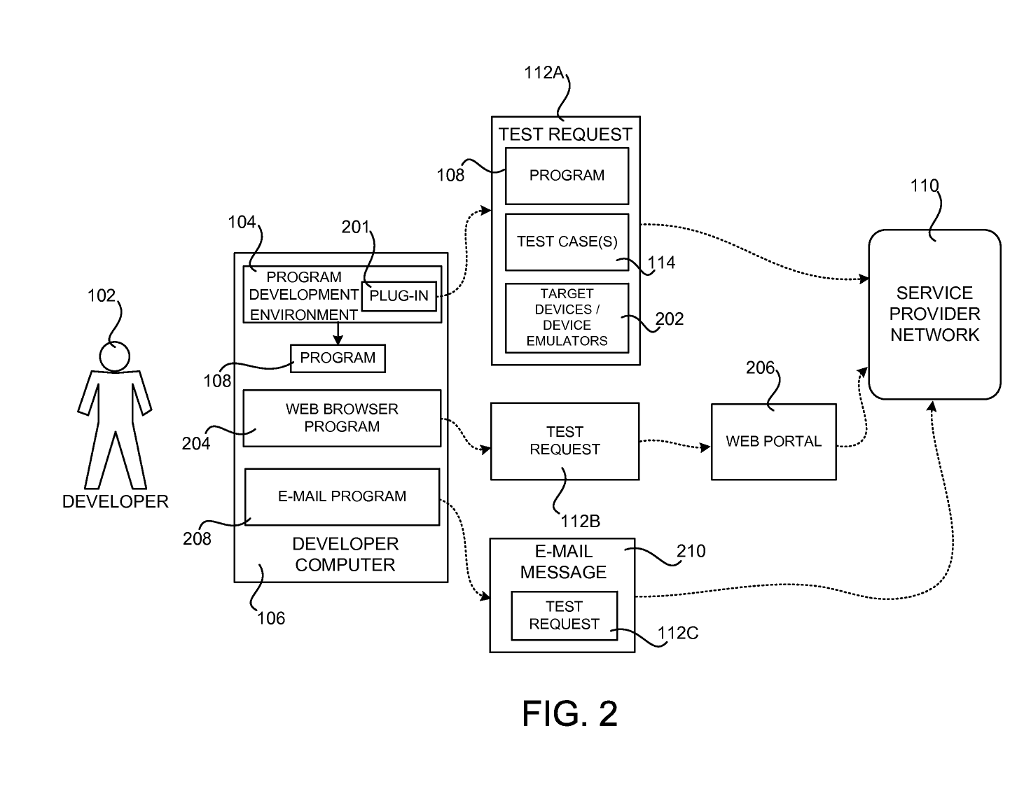

Once the developer 102 has received the test results 124, the developer 102 might utilize the test results 124 to modify the operation of the program 108. The developer 102 might then utilize the testing service described above repeatedly to continue testing the operation of the program 108. Additional details regarding the operation of the various components on the developer computer 106 and within the service provider network 110 will be provided below with regard to FIGS. 2-5.

FIG. 2 is a network architecture diagram showing aspects of one illustrative mechanism described herein for submitting a test request 112 to a program testing service to test the operation of a program 108, according to one embodiment disclosed herein. As described briefly above, a developer 102 might utilize various software components on a developer computer 106 to transmit a test request 112 to the service provider network 110 described above. FIG. 2 provides additional aspects regarding the various components that might be utilized in various embodiments to submit a test request 112 to the service provider network 110.

In one implementation, a plug-in 201 to the program development environment 104 is provided for submission of a test request 112A to the service provider network 110. The plug-in 201 might execute within the program development environment 104, and provides functionality for presenting a list of available computing devices 118A-118N and/or device emulators 122A-122N for use in testing the operation of the program 108. Once a developer 102 has selected the computing devices 118A-118N and/or device emulators 122A-122N for use in testing the program 108, the plug-in 201 may transmit a test request 112A to the service provider network 110.

As shown in FIG. 2 and described briefly above, the test request 112A includes the program 108 to be tested, one or more test cases 114 describing how the testing should occur, and data 202 identifying the computing devices 118A-118N and/or the device emulators 122A-122N upon which the testing should be performed. As mentioned above, a reference to the program 108 and/or the test cases 114 might be provided in a test request 112A rather than the actual program 108 and test cases 114. Other mechanisms might also be utilized to supply the program 108 and the test cases 114 to the service provider network 110.

In another implementation, the service provider network 110 is configured to provide a Web portal 206, or another type of information page, through which a developer 102 can transmit a test request 112. For instance, in the example shown in FIG. 2, the service provider network 110 is configured to provide a Web portal 206 through which the developer 102 can transmit a test request 112B. As also illustrated in FIG. 2, a Web browser program 204, or other suitable program, might be utilized to access the Web portal 206 and transmit the test request 112B. The Web portal 206 might also include functionality for allowing a developer 102 to specify the computing devices 118A-118N and/or device emulators 122A-122N upon which the program 108 should be tested.

In yet another implementation, a developer 102 might utilize an e-mail program 208 executing on the developer computer 106 to create and transmit an e-mail message 210 that includes a test request 112C. The program 108, test cases 114, and data 202 identifying the computing devices 118 and/or the device emulators 122 to utilize for testing, may be attached to the e-mail message 210. Alternately, the e-mail message 210 might include a reference to the network location of the program 108, the test cases 114, and the data 202 identifying the computing devices 118A-118N and/or device emulators 122A-122N that should be utilized to test the operation of the program 108.

It should be appreciated that the mechanisms described with regard to FIG. 2 are merely illustrative. In other implementations, other mechanisms might be utilized in order to allow a developer 102 to transmit a test request 112 to a service provider network 110 that provides a service for testing a program 108. The mechanisms shown in FIG. 2 are merely illustrative and the claims appended hereto should not be limited to these particular mechanisms.

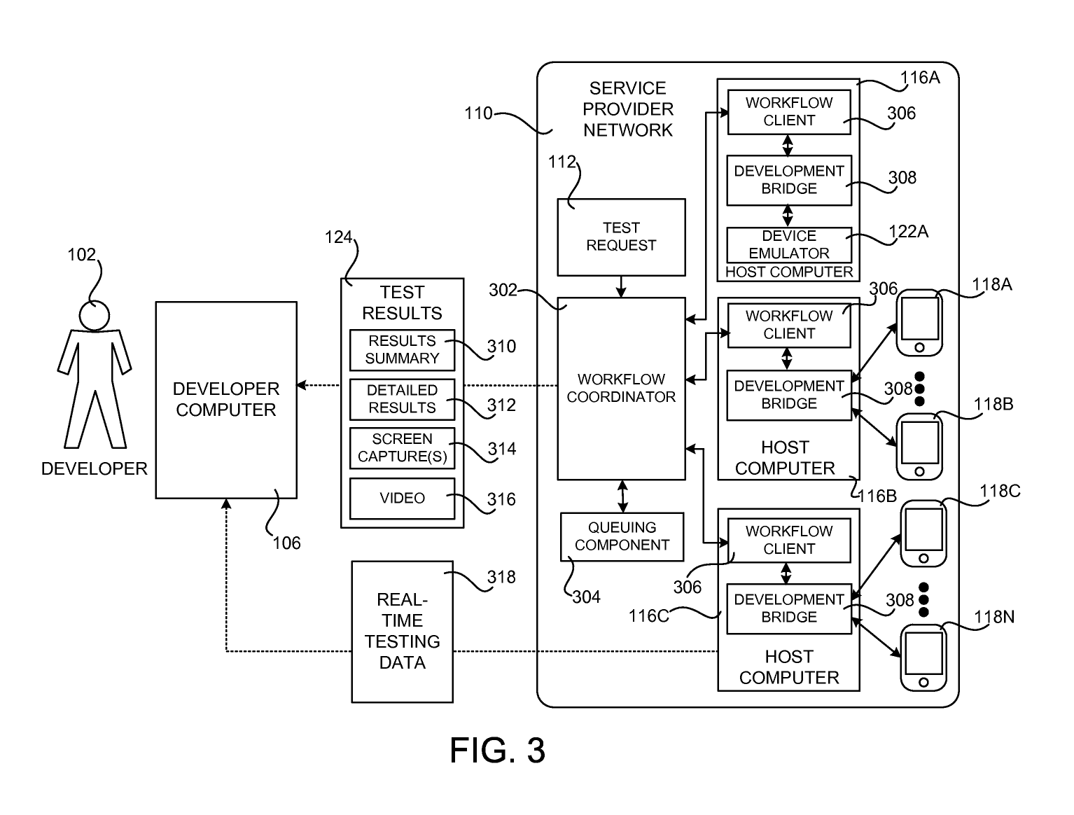

FIG. 3 is a network architecture diagram showing aspects of one illustrative mechanism described herein for testing the operation of a program 108, and for returning test results 124 to a requestor following the testing, according to one embodiment disclosed herein. As shown in FIG. 3 and described briefly above, the service provider network 110 provides a network-based service for testing the operation of a program 108. As mentioned above, the program 108 might be submitted to the service provider network 110 in a test request 112, or in another manner.

In one implementation, a workflow coordinator 302 within the service provider network 110 receives the test request 112. As will be described in greater detail herein, the workflow coordinator 302 is a component that is configured to assign test requests 112 to host computers 116A-116C within the service provider network 110. The workflow coordinator 302 might also receive test results 124 from the various host computers 116A-116C and provide the test results 124 to the developer computer 106 that submitted the test request 112. Details regarding the test results 124 will be provided below.

In response to receiving a test request 112, the workflow coordinator 302 is configured in one embodiment to determine whether the computing devices 118A-118N and/or the device emulators 122A0-122N requested in the test request 112 are available for use in testing the program 108. If the requested computing devices 118A-118N and/or the device emulators 122A-122N are not available, the workflow coordinator 302 might utilize a queuing component 304 to queue the test request 112 the requested computing devices 118A-118N and/or device emulators 122A-122N become available. In some implementations, all of the tests requested by a test request 112 may be queued if any of the computing devices 118A-118N or device emulators 122A-122N are unavailable. In other embodiments, only those tests requested by a test request 112 destined for unavailable computing devices 118A-118N and/or unavailable device emulators 122A-122N might be queued. Other mechanisms might also be utilized for queuing test requests 112 in other implementations.

If the computing devices 118A-118N and/or device emulators 122A-122N upon which a test of a program 108 is to be performed are available, the workflow coordinator 302 transmits the test request 112 to workflow clients 306 executing on the host computers 116A-116C. For example, if a test request 112 indicates that a test should be performed on a program 108 while executing on a computing device 118A, the workflow coordinator 302 may transmit the test request 112 to the workflow client 306 executing on the host computer 116B. In a similar fashion, if a test request 112 indicates that a test is to be performed using a device emulator 122A, the workflow coordinator 302 may transmit the test request 112 to the workflow client 306 executing on the host computer 116A.

The workflow client 306 executing on each of the host computers 116A-116C is configured to receive test requests 112 from the workflow coordinator 302. In response to receiving a test request 112, the workflow client 306 causes a development bridge 308 to install the program 108 on the computing device 118 or the device emulator 122 to be tested. The development bridge 308 provides a mechanism for interacting with a connected computing device 118 or device emulator 122. In one particular implementation, the development bridge 308 is the ANDROID Debug Bridge. The ANDROID Debug Bridge is utilized when the computing devices 118A-118N and/or the device emulators 122A-122N utilize the ANDROID OPERATING SYSTEM. Other types of bridges might also be utilized when computing devices 118A-118N and/or device emulators 122A-122N configured with other operating systems from other manufacturers are utilized to test the operation of a program 108.

Once the program 108 to be tested has been installed on the computing devices 118A-118N and/or device emulators 122A-122N upon which testing should occur, the test cases 114 submitted with the test request 112 are utilized to test the operation of the program 108. As described above with regard to FIG. 1, the test cases 114 might test various aspects the operation of a program 108 on the target computing devices 118A-118N and/or device emulators 122A-122N. For example, the test cases 114 might test the ability of a user to interact with the program 108, send user actions such as key-presses to the program 108, mimic changes in orientation of the computing devices 118A-118N and/or device emulators 122A-122N, programmatically assert on different variables used in the program 108, verify and/or assert the text displayed in different in UI elements by the program 108, and provide other kinds of tests.

In one particular implementation, the host computers 116A-116C are configured to transmit real-time testing data 318 to the developer computer 106 while the testing of the program 108 is being performed. For example, in some implementations, the real-time testing data 318 includes text data describing the on-going testing of a program 108 on a particular computing device 118A-118N or device emulator 122A-122N. In other implementations, the real-time testing data 318 may include a video display output generated by one of the computing devices 118A-118N and/or device emulators 122A-122N utilized for testing. The real time testing data 318 might then be presented on the developer computer 106 for viewing by the developer 102. In this manner, the developer 102 can view the real time operational testing of the program 108 on a computing device 118A-118N or device emulator 122A-122N. When multiple tests are being performed simultaneously, a mechanism might be utilized at the developer computer 106 that allows the developer 102 to select a computing device 118A-118N and/or device emulator 122A-122N for which the real-time testing data 318 is displayed.

Once the testing of the program 108 has completed on the computing devices 118A-118N and/or the device emulators 122A-122N, each of the host computers 116A-116C provides test results 124 to the workflow coordinator 302. In turn, the workflow coordinator 302 provides the test results 124 to the developer computer 106. As shown in FIG. 3, the test results 124 might include a results summary 310, which indicates whether the particular tests passed or failed. The test results 124 might also include detailed results 312 that include detailed information regarding the performance of the tests on the computing devices 118A-118N and/or device emulators 122A-122N. For example, the detailed results 312 might include log files and/or other detailed results generated by the computing device 118, emulator 122, and/or development bridge 308 during the testing of the program 108 on the computing devices 118A-118N and/or the device emulators 122A-122N.

In some implementations, the test results 124 also include one or more screen captures 314 taken on the computing devices 118 and/or the device emulators 122 during the testing of the program 108. Similarly, the test results 124 might also include video 316 captured from the computing devices 118 and/or the device emulators 122 during all or a portion of the testing of the program 108. In this regard, it should be appreciated that the content of the test results 124 illustrated in FIG. 3 are merely illustrative and that other types of information might be provided in the test results 124.

Appropriate functionality might also be provided at the developer computer 106 for presenting the test results 124 to the developer 102. Utilizing the test results 124, the developer 102 can make changes to the program 108 utilizing the program development environment 104. The developer 102 might then resubmit the program 108 to the service provider network 110 for continued testing in the manner described above.

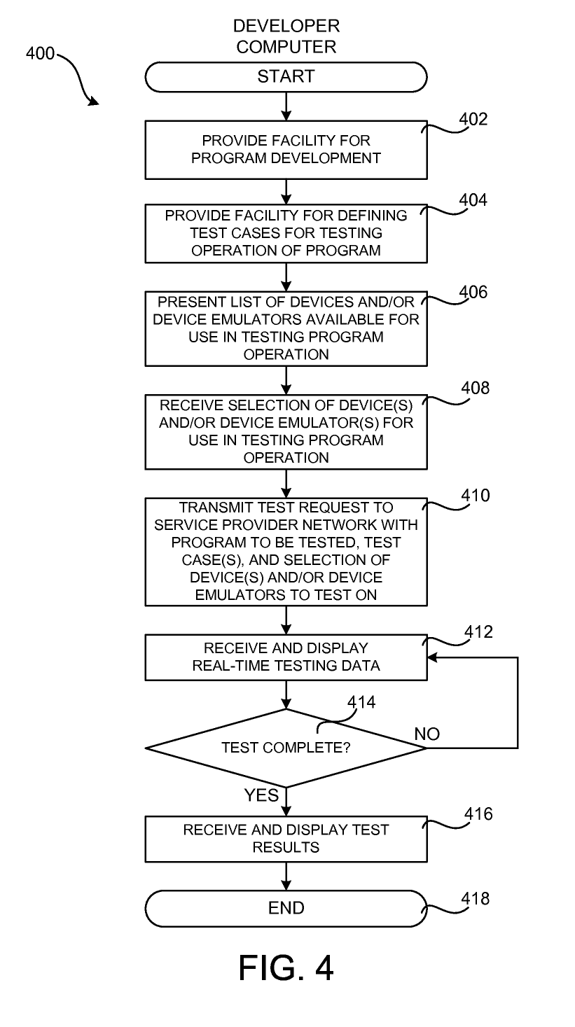

FIG. 4 is a flow diagram showing one illustrative routine 400 that illustrates aspects of the operation of the developer computer 106 for requesting that a network-based program service test a program 108, and for receiving and presenting the results 124 of the testing of the program 108, according to one embodiment disclosed herein. It should be appreciated that the logical operations described herein with respect to FIG. 4, and the other FIGS. may be implemented (1) as a sequence of computer implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the FIGS. and described herein. These operations may also be performed in parallel, or in a different order than those described herein.

The routine 400 begins at operation 402, where a facility is provided on the developer computer 106 for developing the program 108. As described above, a program development environment 104 might be utilized in various embodiments to develop the program 108. As also mentioned briefly above, a facility might also be provided at the developer computer 106 for defining the test cases 114 that should be utilized for testing the operation of the program 108. This occurs at operation 404 of the routine 400.

Once the developer 102 has developed the program 108 and the test cases 114, a list of the computing devices 118A-118N and/or device emulators 122A-122N that are available through the service provider network 110 for use in testing the operation of the program 108 may be presented. As mentioned above, such a list may be presented through a plug-in 201 provided in the program development environment 104 or through a Web portal 206 provided by the service provider network 110. Other mechanisms might also be utilized to provide a list of the available computing devices 118A-118N and the device emulators 122A-122N for testing operation of the program 108.

From operation 406, the routine 400 proceeds to operation 408 where a selection of computing devices 118A-118N and/or device emulators 122A-122N for use in testing the operation of the program 108 is received from the developer 102. In response thereto, the routine 400 proceeds to operation 410, where a test request 112 is transmitted to the service provider network 110. As discussed above, the test request 112 might include the program 108, or a reference to the program 108, the test cases 114, and data identifying the computing devices 118A-118N and/or device emulators 122A-122N upon which testing should occur.

From operation 410, the routine 400 proceeds to operation 412, where the developer computer 106 may receive real-time testing data 318 from the service provider network 110. As described above, the real-time testing data 318 might include textual or graphic images generated by a host computer 116 during the testing of a program 108. An appropriate component on the developer computer 106, such as the plug-in 201, or the Web browser program 204 may be utilized to present the real-time testing data 318 to the developer 102.

From operation 412, the routine 400 proceeds to operation 414, where a determination is made as to whether the test of the program 108 has been completed on the service provider network 110. If testing has not been completed, the routine 400 may proceed back to operation 412 where the real-time testing data 318 may be continually presented to the developer 102. If the testing is complete, the routine 400 proceeds from operation 414 to operation 416.

At operation 416, the developer computer 106 receives and presents the test results 124. As discussed above, the test results 124 might include a results summary 310, detailed results 312, screen captures 314, and/or video 316 in various embodiments. An appropriate component executing on the developer computer 106, such as the plug-in 201 or the Web browser program 204 may be utilized to present the test results 124 to the developer 102. From operation 416, the routine 400 proceeds to operation 418 where it ends.

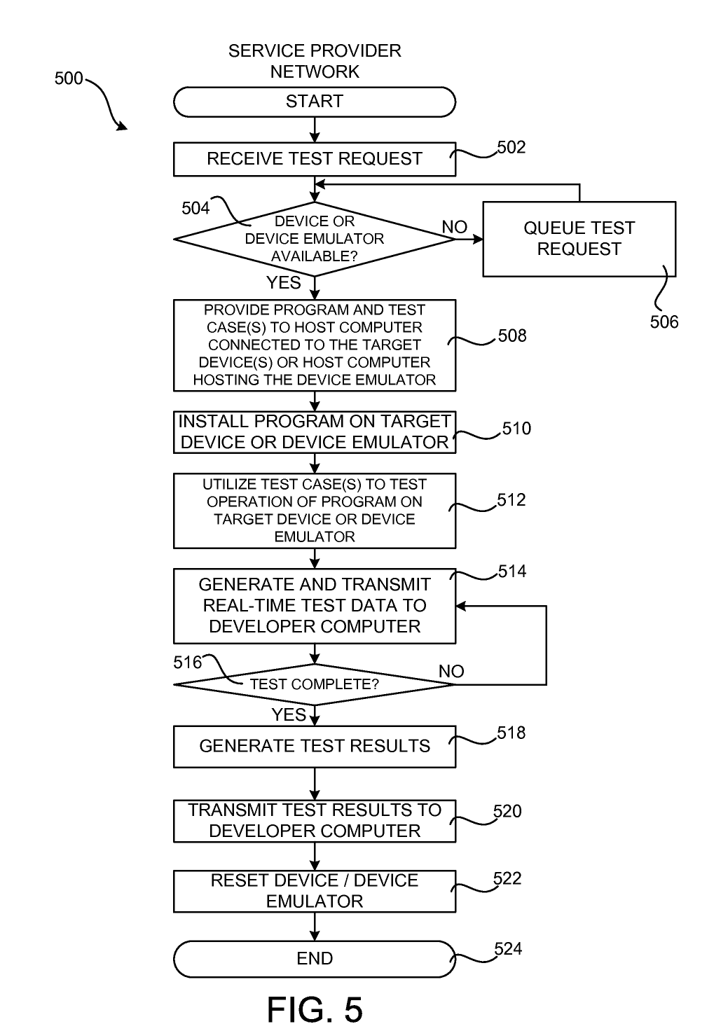

FIG. 5 is a flow diagram showing one illustrative routine 500 that illustrates aspects of the operation of components in a service provider network 110 for testing the operation of a program 108, and for providing results 124 of the testing, according to one embodiment disclosed herein. The routine 500 begins at operation 502, where the service provider network 110 receives a test request 112. In response to receiving a test request 112, the workflow coordinator 302 or another component within the service provider network 110, determines whether the requested computing devices 118A-118N and/or device emulators 122A-122N are available for use in testing the program 108. If the requested computing devices 118 and/or device emulators 122 are not available, the routine 500 may proceed to operation 506, where the test request 112 may be queued. As discussed above, a queuing component 304 may be provided in the service provider network 110 for queuing test requests 112 until the requested computing devices 118A-118N and/or device emulators 122A-122N become available.

If, at operation 504, the workflow coordinator 302 determines that the requested computing devices 118A-118N and/or device emulators 122A-122N are available, the routine 500 proceeds from operation 504 to operation 508. At operation 508, the workflow coordinator 302 provides the test request 112, including the program 108, to host computers 116A-116C hosting the computing devices 118A-118N and/or device emulators 122A-122N upon which testing should occur. The routine 500 then proceeds to operation 510, where the development bridge 308 on the respective host computer 116 installs the program 108 on the computing device 118 and/or device emulators 122 upon which testing is to occur.

Once the program 108 has been installed, the routine 500 proceeds to operation 512 where the test cases 114 provided with the test requests 112 are utilized to test the operation of the program 108 on the computing devices 118A-118N and/or device emulators 122A-122N specified with the test request 112. As mentioned above, real-time testing data 318 might be transmitted to the developer computer 106 during the testing of the program 108. This occurs at operation 514.

From operation 514, the routine 500 proceeds to operation 516, where a determination is made as to whether the testing of the program 108 has been completed. If testing has not been completed, the routine 500 proceeds back to operation 514, where the service provider network 110 may continue to transmit real-time testing data 318 to the developer computer 106 in the manner described above. If, however, testing of the program 108 has been completed, the service provider network 110 generates the test results 124. As mentioned above, the test results 124 might include the results summary 310, detailed results 312, screen captures 314, and/or video 316 in various embodiments. The test results 124 might also include other data not specifically mentioned herein.

From operation 518, the routine 500 proceeds to operation 520, where the test results 124 are transmitted to the developer computer 106 for presentation to the developer 102, or use in another manner. Once the test results 124 have been transmitted to the developer computer 106, a component within the service provider network 110, such as the development bridge 308, is utilized to reset the computing devices 118A-118N and/or device emulators 122 upon which testing occurred. In this way the computing devices 118 and/or device emulators 122 can be placed into a baseline state for future testing. From operation 522, the routine 500 proceeds to operation 524 where it ends.

In some embodiments, the results of the testing described above might be stored for future use by the developer 102. For example, the test results 124 might be stored at the service provider network 110, at the developer computer 106, or in another location. A mechanism might also be provided for allowing the developer 102 to review the stored test results 124. For example, a Web portal or other type of suitable user interface might be provided for reviewing previously generated and stored test results 124.

It should be appreciated that while the embodiments disclosed herein have been primarily presented in the context of testing a program 108, the embodiments disclosed herein might be utilized for other types of testing. For example, in one particular implementation, the testing service described above might be utilized to test Web pages. In such an implementation, a Web page to be tested might be loaded by a Web browser application executing on one or more of the computing devices 118A-118N and/or device emulators 122A-122N. The rendering and operating of the Web page may then be tested utilizing appropriate test cases 114. Test results 124 may then be provided in the manner described above.

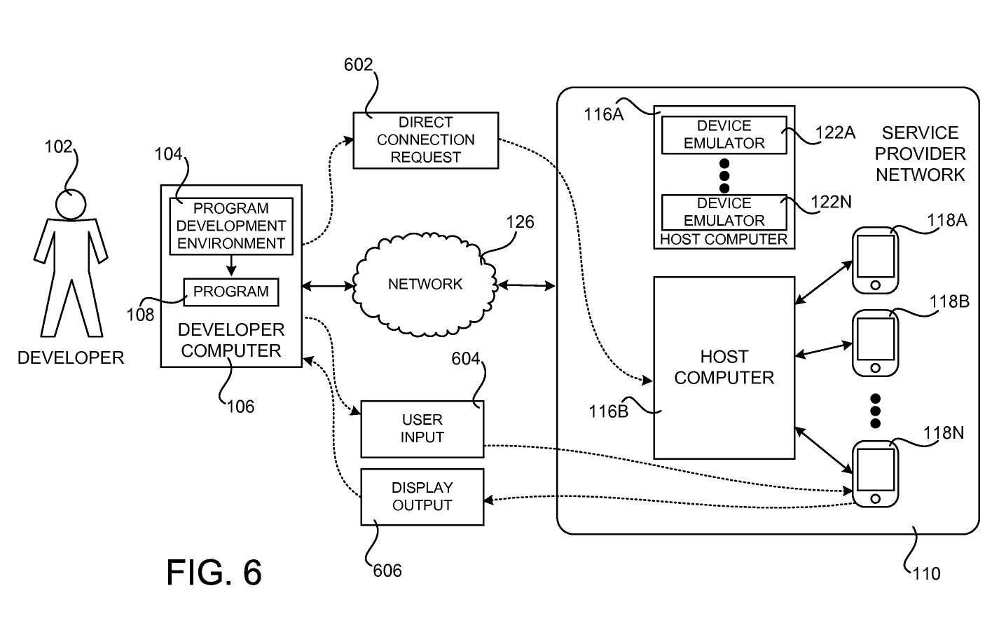

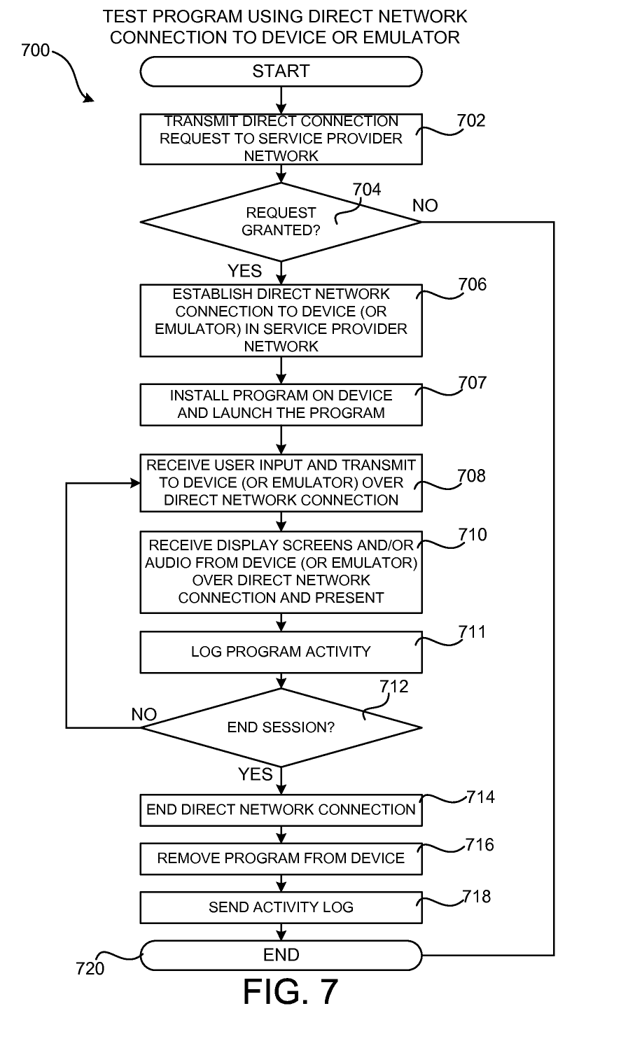

In another implementation, shown in FIG. 6 and described in greater detail below with regard to FIG. 7, the developer computer 106 might be configured to establish a direct network connection to one of the computing devices 118A-118N and/or device emulators 122A-122N for use in testing the operation of the program 108. Through such a connection, the developer 102 can interact with the device 118 or emulator 122 to provide user input 604 for testing the operation of the program 108 on the device 118 or emulator 122. The developer 102 can also view display output 606 generated by the emulator 122 or device 118.

In the embodiment shown in FIG. 6, the program development environment 104, a plug-in to the program development environment 104, or another program executing on the developer computer 106, may be configured to transmit a direct connection request 602 to the service provider network 110 to establish a direct network connection to one of the computing devices 118A-118N or one of the device emulators 122A-122N. In response to receiving such a request 602, the host computer 116A or 116B hosting the requested emulator 122 or device 118 might determine if the emulator 122 or device 118 to which a direct connection has been requested is available.

If the emulator 122 or device 118 to which a direct connection has been requested is not available, the request 602 to establish a direct network connection may be declined. For instance, in the embodiment shown in FIG. 6, the request 602 is to establish a direct network connection between the developer computer 106 and the device 118N. In this case, the request 602 may be declined if the device 118N is in use by another developer or otherwise unavailable. The request 602 might be queued in this case or the developer 102 might be instructed to resubmit the request 602 again later.

If the requested emulator 122 or device 118 is available, a direct network connection may be established between the requested emulator 122 or device 118 and the developer computer 106 utilizing a suitable network protocol. Using such a direct network connection, the developer 102 can interact directly with the emulator 122 or device 118 to test aspects of the operation of the program 108 or perform other types of operations. For instance, in the example shown in FIG. 6, a direct network connection has been established between the developer computer 106 and the device 118N. In this embodiment, the developer 102 can provide user input 604, such as touch screen input, keyboard input, and other types of input, to the developer computer 106.

The received user input 604 is then transmitted over the direct network connection to the device 118N. The user input 604 is then presented to the device 118N as if the developer 102 made the user input 604 directly to the device 118N, rather than to the developer computer 102. In this way, the developer 102 can utilize the device 118N as if the developer 102 was physically co-located with the device 118N. In particular, the developer 102 can utilize and test the operation of the program 108 on the device 118N utilizing this mechanism.

In the embodiment shown in FIG. 6, the emulator 122 or device 118 to which a direct network connection has been established might also be configured to transmit the display output 606 of the emulator 122 or device 118 to the developer computer 106. Audio output of the emulator 122 or device 118 might also be transmitted in a similar fashion. Various protocols might be utilized to transmit the display output 606 and/or the audio output of the emulator 122 or device 118, such as the virtual network computing (“VNC”) protocol, the remote desktop protocol (“RDP”), or another suitable protocol.

The developer computer 106 may then receive and present the display output 606 of the connected emulator 122 or device 118. For instance, in the example shown in FIG. 6, the device 118N is transmitting its display output 606 to the developer computer 106 for display to the developer 102. In this way, the developer 102 can view the output of the device 118N in response to the user input 604. The developer 102 can, therefore, test the operation of the program 108 on an emulator 122 or device 118 that is operating in a service provider network 110 in essentially the same manner as if the emulator 122 or device 118 was local to the developer computer 106. Additional details regarding this process are provided below with regard to FIG. 7.

FIG. 7 is a flow diagram showing aspects of one illustrative routine 700 disclosed herein for utilizing a direct network connection between a computing device, such as the developer computer 106, and an emulator 122, or a device 118, in a service provider network 110 to test the operation of a program 108, according to one embodiment disclosed herein. The routine 700 begins at operation 702, where the developer computer 106 transmits a direct connection request 602 to a component in the service provider network 110 such as the host computer 116B. The direct connection request 602 may include data identifying the particular emulator 122 or device 118 to which a direct network connection is requested.

From operation 702, the routine 700 proceeds to operation 704, where the developer computer 106 determines whether the direct connection request 602 has been granted. If the request 602 has not been granted, the routine 700 proceeds to operation 716, where it ends. If, however, the direct connection request 602 is granted, the routine 700 proceeds from operation 706 to operation 708.

At operation 708, the developer computer 106 establishes a direct network connection the requested emulator 122 or device 118 in the service provider network 110. For example, the service provider network 110 might provide a network address of the emulator 122 or device 118 to the developer computer 106 in response to the request 602. Utilizing the provided network address, the developer computer 106 might establish a direct network connection to the requested emulator 122 or device 188 utilizing a suitable network communications protocol.

Once the direct network connection has been established, the routine 700 proceeds from operation 706 to operation 707, where the program 108 to be tested may be loaded on the emulator 122 or device 188 to which the direct network connection has been established. Once the program 108 has been installed, execution of the program 108 is started. The routine 700 then proceeds from operation 707 to operation 708.

At operation 708, the developer computer 106 receives user input 604 from the developer 102, or other user. The developer computer 106 then transmits the user input 604 to the connected emulator 122 or device 118. As mentioned above, the user input 604 may then be presented to the connected emulator 122, or device 118, as if the user input 604 was made locally to the emulator 122 or device 118.

From operation 708, the routine 700 proceeds to operation 710, where the connected emulator 122 or device 118 generates a display output 606 and transmits the display output 606 to the developer computer 106. For example, the display output 606 may be made by the program 108 executing on the particular emulator 122 or device 118. As mentioned above, the display output 606 might be formatted utilizing a suitable protocol, such as VNC or RDP. The developer computer 106 then receives the display output 606 and displays the display output 606 at operation 710. As mentioned above, the connected emulator 122 or device 118 might also transmit audio to the developer computer 106 for playback by the developer computer 106 in a similar manner.

From operation 710, the routine 700 proceeds to operation 711, where activity performed on the emulator 122 or device 188 might be logged in the manner described above. Data from the activity log might be provided to the developer 102 in real-time while the direct network connection is being utilized or following the direct connect session (at operation 718, described below).

From operation 711, the routine 700 proceeds to operation 712, where the developer computer 106 determines whether the developer 102 has requested to end the direct network connection to the emulator 122 or device 118. If the developer 102 has not requested to end the direct network connection, the routine 700 proceeds back to operation 708, where user input 604 may be continually provided to the connected emulator 122 or device 118, and to operation 710 where display output 606 generated by the connected emulator 122 or device 118 may be continually received and presented at the developer computer 106. In some embodiments, the direct network connection might be time-limited for some period of time. For example, a developer 102 might be limited to 15 minutes or some other period of time for utilizing a direct network connection to test a device 118 in the manner described above.

If the developer 102 (or the service provider network 110) has requested to discontinue the direct network connection or the session time limit has expired, the routine 700 proceeds to operation 714, where the direct network connection is ended. The routine 700 then proceeds from operation 714 to operation 716, where the program 108 is removed from the emulator 122 or device 188. The routine 700 then proceeds to operation 718, where the activity log described above might be transmitted to the developer computer 106. From operation 718, the routine 700 proceeds to operation 720, where it ends.

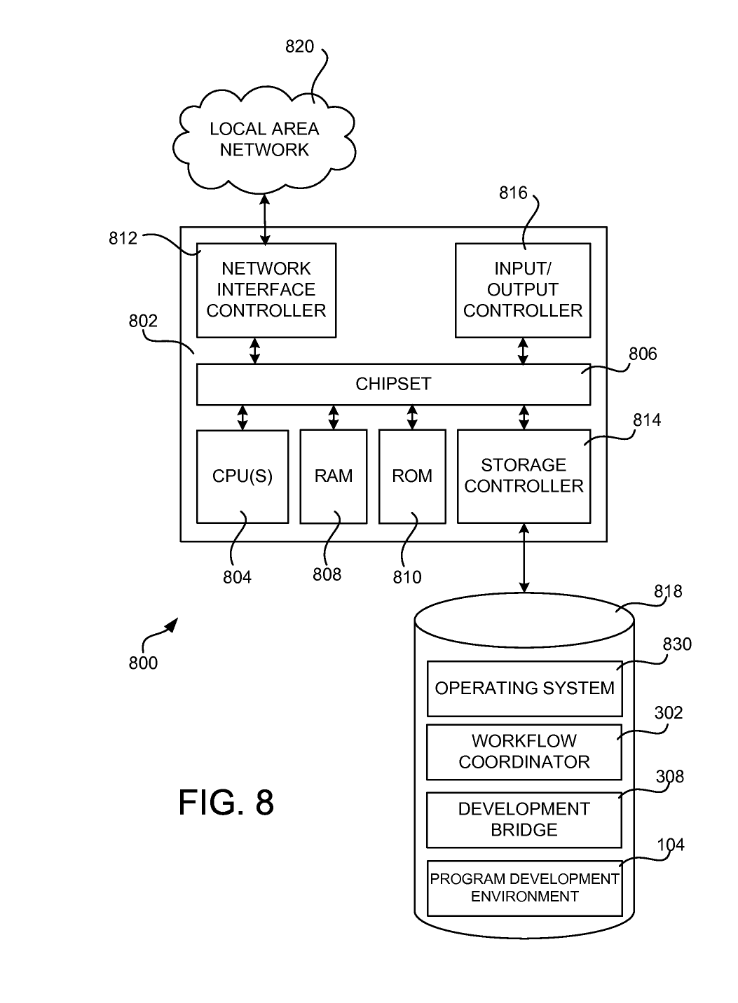

FIG. 8 shows an example computer architecture for a computer 800 capable of executing the program components described above for providing and utilizing a network-based program testing service The computer architecture shown in FIG. 8 illustrates a conventional server computer, workstation, desktop computer, laptop, tablet computing device, network appliance, personal digital assistant (“PDA”), e-reader, digital cellular phone, or other computing device, and may be utilized to execute any aspects of the software components presented herein. For example, the computer architecture shown in FIG. 8 may be utilized to execute the workflow coordinator 302, the development bridge 308, the program development environment 104, and/or the other components shown in FIGS. 1-3 and described above.

The computer 800 includes a baseboard 802, or “motherboard,” which is a printed circuit board to which a multitude of components or devices may be connected by way of a system bus or other electrical communication paths. In one illustrative embodiment, one or more central processing units (“CPUs”) 804 operate in conjunction with a chipset 806. The CPUs 804 may be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 may provide an interface to a random access memory (“RAM”) 808, used as the main memory in the computer 800. The chipset 806 may further provide an interface to a computer-readable storage medium such as a read-only memory (“ROM”) 810 or non-volatile RAM (“NVRAM”) for storing basic routines that help to startup the computer 800 and to transfer information between the various components and devices. The ROM 810 or NVRAM may also store other software components necessary for the operation of the computer 800 in accordance with the embodiments described herein.

The computer 800 may operate in a networked environment using logical connections to remote computing devices and computer systems through a network, such as the local area network 820. The chipset 806 may include functionality for providing network connectivity through a NIC 812, such as a gigabit Ethernet adapter. The NIC 812 is capable of connecting the computer 800 to other computing devices over the network 820. It should be appreciated that multiple NICs 812 may be present in the computer 800, connecting the computer to other types of networks and remote computer systems.

The computer 800 may be connected to a mass storage device 818 that provides non-volatile storage for the computer. The mass storage device 818 may store system programs, application programs, other program modules, and data, which have been described in greater detail herein. The mass storage device 818 may be connected to the computer 800 through a storage controller 814 connected to the chipset 806. The mass storage device 818 may consist of one or more physical storage units. The storage controller 814 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 800 may store data on the mass storage device 818 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 818 is characterized as primary or secondary storage, and the like.

For example, the computer 800 may store information to the mass storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 may further read information from the mass storage device 818 by detecting the physical states or characteristics of one or more particular locations within the physical storage units.

In addition to the mass storage device 818 described above, the computer 800 may have access to other computer-readable storage media to store and retrieve information, such as program modules, data structures, or other data. It should be appreciated by those skilled in the art that computer-readable storage media can be any available media that provides for the storage of non-transitory data and that may be accessed by the computer 800.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 818 may store an operating system 830 utilized to control the operation of the computer 800. According to one embodiment, the operating system comprises the LINUX operating system. According to another embodiment, the operating system comprises the WINDOWS® SERVER operating system from MICROSOFT Corporation. According to further embodiments, the operating system may comprise the UNIX or SOLARIS operating systems. It should be appreciated that other operating systems may also be utilized. The mass storage device 818 may store other system or application programs and data utilized by the computer 800, such as the workflow coordinator 302, the development bridge 308, the program development environment 104, and/or any of the other software components and data described above. The mass storage device 818 might also store other programs and data not specifically identified herein.

In one embodiment, the mass storage device 818 or other computer-readable storage media is encoded with computer-executable instructions which, when loaded into the computer 800, transforms the computer from a general-purpose computing system into a special-purpose computer capable of implementing the embodiments described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various routines described above with regard to FIGS. 4 and 5. The computer 800 might also include computer-readable storage media for performing any of the other computer-implemented operations described herein.

The computer 800 may also include one or more input/output controllers 816 for receiving and processing input from a number of input devices, such as a keyboard, a mouse, a touchpad, a touch screen, an electronic stylus, or other type of input device. Similarly, the input/output controller 816 may provide output to a display, such as a computer monitor, a flat-panel display, a digital projector, a printer, a plotter, or other type of output device. It will be appreciated that the computer 800 may not include all of the components shown in FIG. 8, may include other components that are not explicitly shown in FIG. 8, or may utilize an architecture completely different than that shown in FIG. 8.

Based on the foregoing, it should be appreciated that technologies for implementing and utilizing a network-based program testing service have been presented herein. Moreover, although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the example embodiments and applications illustrated and described, and without departing from the true spirit and scope of the present invention, which is set forth in the following claims.

What is claimed is:

1. A computer-readable storage medium having computer-executable instructions stored thereupon which, when executed by a computer, cause the computer to:
receive, at a service provider network, a request from a computing device to establish a direct network connection between the computing device and a smartphone, the smartphone comprising one of plurality of smartphones connected to one or more host computers in the service provider network;
in response to receiving the request, to cause the direct network connection to be established between the computing device and the smartphone;
receive user input from the computing device by way of the direct network connection;
provide the user input received from the computing device by way of the direct network connection to the smartphone;
receive display output from the smartphone; and
provide the display output received from the smartphone to the computing device by way of the direct network connection.

2. The computer-readable storage medium of claim 1, wherein the user input comprises user input for testing operation of a program executing on the smartphone.

3. The computer-readable storage medium of claim 2, wherein the program executing on the smartphone generates the display output.

4. The computer-readable storage medium of claim 3, wherein the request to establish the direct network connection is generated from within a program development environment executing on the computing device.

5. The computer-readable storage medium of claim 4, having further computer-executable instructions stored thereupon which, when executed by the computer, cause the computer to:
receive audio from the smartphone; and
provide the audio received from the smartphone to the computing device by way of the direct network connection.

6. The computer-readable storage medium of claim 4, having further computer-executable instructions stored thereupon which, when executed by the computer, cause the computer to queue the request to establish the direct network connection between the computing device and the smartphone if the smartphone is unavailable at the time the request is received.

7. The computer-readable storage medium of claim 1, having further computer-executable instructions stored thereupon which, when executed by the computer, cause the computer to:
generate a log of activity performed on the smartphone while the direct network connection is active; and
provide the log to the computing device.

8. A computer-implemented method for testing the operation of a program, the method comprising performing computer-implemented operations for:
establishing a direct network connection between a developer computer and a mobile computing device in a service provider network, the mobile computing device comprising one of a plurality of mobile computing devices connected to a host computer in the service provider network; and
transmitting data over the direct network connection between the developer computer and the mobile computing device in the service provider network for testing the operation of a program executing on the mobile computing device in the service provider network.

9. The computer-implemented method of claim 8, wherein the data transmitted over the direct network connection comprises user input generated at the developer computer and received at the mobile computing device.

10. The computer-implemented method of claim 9, wherein the user input comprises user input for testing the operation of the program executing on the mobile computing device in the service provider network.

11. The computer-implemented method of claim 10, wherein the data transmitted over the direct network connection comprises display output generated by the program executing on the mobile computing device in the service provider network.

12. The computer-implemented method of claim 11, wherein the display output is received and displayed at the developer computer.

13. The computer-implemented method of claim 8, wherein the data transmitted over the direct network connection comprises audio generated by the mobile computing device in the service provider network.

14. The computer-implemented method of claim 13, wherein the developer computer is further configured to receive and playback the audio.

15. The computer-implemented method of claim 8, wherein the mobile computing device comprises a smartphone.

16. The computer-implemented method of claim 8, wherein the mobile computing device comprises a tablet computing device.

17. The computer-implemented method of claim 8, wherein the mobile computing device comprises a development motherboard for a mobile computing device.

18. A system for testing a program, the system comprising:
a computer configured to establish a direct network connection with a mobile computing device in a service provider network and to transmit user input received at the computer to the mobile computing device in the service provider network by way of the direct network connection; and
a mobile computing device in the service provider network, the mobile computing device comprising one of a plurality of mobile computing devices connected to a host computer in the service provider network, the mobile computing device configured to transmit display output to the computer by way of the direct network connection.

19. The system of claim 18, wherein the computer is further configured to receive the display output from the mobile computing device by way of the direct network connection and to display the display output.

20. The system of claim 18, wherein the mobile computing device is further configured to receive the user input by way of the direct network connection and to provide the user input to a program executing on the mobile computing device.

21. The system of claim 20, wherein the user input comprises user input for testing the operation of the program executing on the mobile computing device in the service provider network.

22. The system of claim 18, wherein the mobile computing device comprises a smartphone.

23. The system of claim 18, wherein the mobile computing device comprises a tablet computing device.

24. The system of claim 18, wherein the mobile computing device comprises a development motherboard for a mobile computing device.
